(19) United States
(12) Patent Application Publication
(10) Pub. No.: US 2022/0200826 A1
(43) Pub. Date: Jun. 23, 2022

(54) COMMUNICATION METHOD, ELECTRONIC APPARATUS, PROCESSING APPARATUS, AND ELECTRONIC DEVICE

(71) Applicant: HUAWEI TECHNOLOGIES CO., LTD., Shenzhen (CN)

(72) Inventors: Junwei ZHONG, Dongguan (CN); Yongyao LI, Shenzhen (CN)

(73) Assignee: HUAWEI TECHNOLOGIES CO., LTD., Shenzhen (CN)

(21) Appl. No.: 17/557,260

(22) Filed: Dec. 21, 2021

(30) Foreign Application Priority Data
Dec. 22, 2020 (CN) 202011528055.1

(51) Int. Cl. H04L 25/03; H04L 25/02; H04L 1/20; H04L 1/24

(52) U.S. Cl. CPC H04L 25/03878; H04L 1/24; H04L 1/20; H04L 25/0298

(57) ABSTRACT

A communication method is applicable to a processing apparatus that includes a processor and a communications interface. The processor determines a first parameter corresponding to the communications interface, wherein the communications interface is connected to at least one storage apparatus and communicates with the at least one storage apparatus based on the first parameter. In this way, the processor determines a parameter used to improve a quality of signal transmission and integrity during communication between the processing apparatus and the at least one storage apparatus.

### CROSS-REFERENCE TO RELATED APPLICATIONS

This application claims priority to Chinese Patent Application No. 202011528055.1, filed on Dec. 22, 2020, which is hereby incorporated by reference in its entirety.

### TECHNICAL FIELD

A communication method, an electronic apparatus, a processing apparatus, and an electronic device are related to the field of data storage.

### BACKGROUND

With development of information and communications technology (ICT), a computing capability of a processor is constantly enhanced, and a relatively high requirement is imposed on a rate of signal transmission between the processor and a memory.

Quality of signal transmission between the processor and the memory limits a maximum rate of signal transmission. Therefore, how to improve quality of signal transmission between the processor and the memory is an urgent problem.

### SUMMARY

A communication method, an electronic apparatus, a processing apparatus, and an electronic device improve a quality of signal transmission between a communications interface and a storage apparatus connected to the communications interface.

According to a first aspect, a communication method is provided. The method includes determining a first parameter corresponding to a communications interface, where the communications interface is connected to at least one storage apparatus; and controlling the communications interface to communicate with the at least one storage apparatus based on the first parameter.

A parameter used when the communications interface communicates with the at least one storage apparatus is determined, to improve quality of signal transmission during communication between the communications interface and the storage apparatus, and improve signal integrity.

With reference to the first aspect, in some possible implementations, the method further includes controlling the communications interface to separately receive, by using a plurality of receiving parameters with different values, first test information sent by the at least one storage apparatus; and recording signal quality information of the first test information received when the communications interface uses the receiving parameter with each value, where the first test information that is received when the communications interface uses the first parameter has optimal signal quality data in a plurality of pieces of recorded signal quality information.

The communications interface is controlled to separately receive, by using the plurality of receiving parameters with different values, the first test information sent by the storage apparatus, to record the signal quality information of the first test information received when the communications interface uses the receiving parameters with different values and determine the first parameter. The first parameter is a receiving parameter in the plurality of receiving parameters with different values that makes signal quality the best. Therefore, the communications interface communicates with the storage apparatus by using the first parameter, and when a processing apparatus receives a signal sent by the storage apparatus, quality of the signal is improved.

With reference to the first aspect, in some possible implementations, the first parameter is an on-die termination (ODT) parameter or a continuous time linear equalization (CTLE) parameter.

The communications interface may be controlled to receive first test information by using ODT parameters with different values to determine an ODT parameter used when the communications interface communicates with the at least one storage apparatus, and receive the first test information by using CTLE parameters with different values to determine a CTLE parameter used when the communications interface communicates with the at least one storage apparatus.

With reference to the first aspect, in some possible implementations, the method further includes controlling the communications interface to separately send second test information to the at least one storage apparatus by using a plurality of transmitting parameters with different values; and controlling the communications interface to receive a plurality of pieces of third test information sent by the at least one storage apparatus, where each piece of third test information is the second test information received by the at least one storage apparatus, the plurality of pieces of third test information are in a one-to-one correspondence with the plurality of transmitting parameters, and the first parameter in the plurality of transmitting parameters makes the third test information corresponding to the first receiving parameter match the second test information.

The communications interface is controlled to send the second test information to the storage apparatus by using the plurality of transmitting parameters with different values, where the second test information received by the storage apparatus is the third test information. The storage apparatus sends the third test information to the processing apparatus. The processing apparatus may determine that a transmitting parameter in the plurality of transmitting parameters with different values that makes the received third test information match the second test information is the first parameter. The communications interface of the processing apparatus uses the first parameter when communicating with storage apparatus. When the processing apparatus sends a signal to the storage apparatus, quality of the signal received by the storage apparatus is improved.

The communications interface should use a same parameter when receiving the pieces of third test information.

With reference to the first aspect, in some possible implementations, in the plurality of transmitting parameters, there are a plurality of transmitting parameters that make the third test information match the second test information, and the first parameter in the plurality of first transmitting parameters has a largest biased voltage range.

When a plurality of first transmitting parameters can make the third test information match the second test information, the first transmitting parameter is determined based on a biased voltage range of each first transmitting parameter. The first transmitting parameter has a largest biased voltage range. The first parameter has a largest biased voltage range is determined, so that when the processing apparatus sends a signal to the storage apparatus, quality of the signal received by the storage apparatus is further improved.

With reference to the first aspect, in some possible implementations, the first parameter is a first driving capability parameter, a first output signal slope, or a first transmitter equalization (EQ) parameter.

For parameters applied to a transmitter, such as the first driving capability parameter, the first output signal slope, and the EQ parameter, a memory may be used to re-send, to the processing apparatus, the received second test information sent by the communications interface of the processing apparatus by using the transmitting parameters with different values, and the processing apparatus determines whether information sent by the storage apparatus matches the second test information sent by the processing apparatus, to determine a parameter applied to the transmitter.

With reference to the first aspect, in some possible implementations, the method further includes determining a second parameter corresponding to each storage apparatus; and controlling the communications interface to send parameter indication information to each storage apparatus, where the parameter indication information includes the second parameter corresponding to the storage apparatus, and the parameter indication information is used to indicate the storage apparatus to communicate with the processing apparatus by using the received second parameter.

The processing apparatus may further determine a second parameter set corresponding to each storage apparatus and indicate each storage apparatus to communicate with the processing apparatus by using the second parameter set corresponding to the storage apparatus, to further improve signal quality in communication between the processing apparatus and the storage apparatus.

According to a second aspect, an electronic apparatus is provided, including a processor and a memory. The memory is configured to store a program, and when the program is executed in the processor, the processor is configured to determine a first parameter corresponding to a communications interface, where the communications interface is connected to at least one storage apparatus; and control the communications interface to communicate with the at least one storage apparatus based on the first parameter.

With reference to the second aspect, in some possible implementations, the processor is further configured to control the communications interface to separately receive, by using a plurality of receiving parameters with different values, first test information sent by the at least one storage apparatus; and record signal quality information of the first test information received when the communications interface uses the receiving parameter with each value, where the first test information that is received when the communications interface uses the first parameter has optimal signal quality data in a plurality of pieces of recorded signal quality information.

With reference to the second aspect, in some possible implementations, the first parameter is an on-die termination (ODT) parameter or a continuous time linear equalization (CTLE) parameter.

With reference to the second aspect, in some possible implementations, the processor is further configured to control the communications interface to separately send second test information to the at least one storage apparatus by using a plurality of transmitting parameters with different values; and control the communications interface to receive a plurality of pieces of third test information sent by the at least one storage apparatus, where each piece of third test information is the second test information received by the at least one storage apparatus, the plurality of pieces of third test information are in a one-to-one correspondence with the plurality of transmitting parameters, and the first parameter in the plurality of transmitting parameters makes the third test information corresponding to the first receiving parameter match the second test information.

With reference to the second aspect, in some possible implementations, in the plurality of transmitting parameters, there are a plurality of first transmitting parameters that make the third test information match the second test information, and the first parameter in the plurality of first transmitting parameters has a largest biased voltage range.

With reference to the second aspect, in some possible implementations, the first parameter is a driving capability parameter, an output signal slope, or a transmitter equalization (EQ) parameter.

With reference to the second aspect, in some possible implementations, the processor is further configured to: determine a second parameter corresponding to each storage apparatus; and control the communications interface to send parameter indication information to each storage apparatus, where the parameter indication information includes the second parameter corresponding to the storage apparatus, and the parameter indication information is used to indicate the storage apparatus to communicate with a processing apparatus by using the received second parameter.

The memory may be one of the at least one storage apparatus or may be another storage apparatus.

According to a third aspect, an electronic apparatus is provided, including a storage unit and a processing unit. The storage unit is configured to store program instructions. When the program instructions are executed in the processing unit, the processing unit is configured to perform the method according to the first aspect.

The storage unit may be one of the at least one storage apparatus or may be another storage apparatus.

According to a fourth aspect, a non-transitory computer-readable medium is provided. The non-transitory computer-readable medium stores program code to be executed by a device, and the program code includes instructions used to perform the method in any implementation of the first aspect.

According to a sixth aspect, a chip is provided. The chip includes a processor and a data interface. The processor reads, through the data interface, instructions stored in a memory, to perform the method in any implementation of the first aspect.

Optionally, in an implementation, the chip may further include the memory. The memory stores the instructions. The processor is configured to execute the instructions stored in the memory. When the instructions are executed, the processor is configured to perform the method in any implementation of the first aspect.

According to a seventh aspect, a processing apparatus is provided, including a communications interface and the electronic apparatus according to the second aspect or the third aspect.

According to an eighth aspect, an electronic device is provided, including at least one storage apparatus and the processing apparatus according to the seventh aspect.

### BRIEF DESCRIPTION OF DRAWINGS

FIG. 1 is a schematic structural diagram of an electronic device;

FIG. 2 is a schematic flowchart of a communication method according to an embodiment;

FIG. 3 is a schematic flowchart of another communication method according to an embodiment;

FIG. 4 is a schematic diagram of a structure of an electronic system according to an embodiment;

FIG. 5 is a schematic diagram of a structure of an electronic apparatus according to an embodiment; and

FIG. 6 is a schematic diagram of a structure of another electronic apparatus according to an embodiment.

### DESCRIPTION OF EMBODIMENTS

The following describes solutions with reference to the accompanying drawings.

As shown in FIG. 1, an electronic device 100 includes a processor 110 and a memory 120. The memory 120 is configured to store a program, data, and the like. The processor 110 obtains the program and the data in the memory 120 and runs the program to process the data in the memory 120 to obtain a processing result. Then the processor 110 may store the processing result in the memory 120.

With development of the information and communications technology (ICT), a computing capability of a processor 110 is constantly enhanced, and a relatively high requirement is imposed on a capacity of a memory 120 and a rate of signal transmission between the processor 110 and the memory 120.

Quality of signal transmission between the processor 110 and the memory 120 limits a maximum rate of signal transmission.

Currently, there is a specific difference between performance of memories 120 produced by using different processes. When the processor 110 communicates with memories 120 with different performance by using a same parameter, signal integrity (SI) is greatly affected. To adapt to different memories 120, the processor 110 may communicate with the memory 120 at a relatively low data transmission rate.

To resolve the foregoing problem, an embodiment provides a communication method.

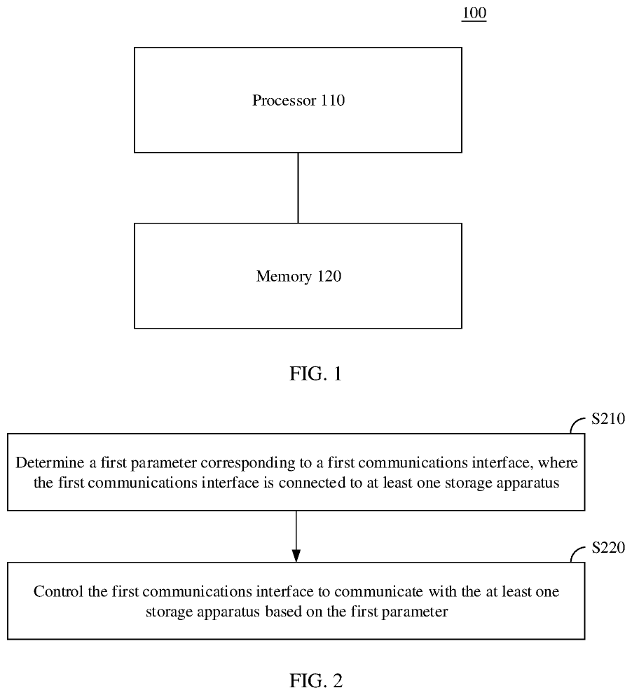

FIG. 2 is a schematic flowchart of a communication method according to an embodiment.

A communication method 200 may be applied to the processor 110 shown in FIG. 1. The processor 110 may be located in an electronic device such as a server, a workstation, a smartphone, a personal computer (PC), or a notebook computer.

The communication method 200 includes steps S210 and S220.

S210: Determine a first parameter corresponding to a first communications interface, wherein the first communications interface is connected to at least one storage apparatus.

S220: Control the first communications interface to communicate with the at least one storage apparatus based on the first parameter.

A processing apparatus may include the processor 110 and the first communications interface. The first parameter corresponding to the first communications interface is determined, and the first communications interface is controlled to communicate with the at least one storage apparatus based on the first parameter, so that signal quality in communication between the processing apparatus and the storage apparatus can be improved, that is, signal integrity (SI) performance can be improved.

S210 and S220 may be performed at an initialization stage of the processor 110.

The first parameter may belong to a first receiving parameter set or a first transmitting parameter set.

The first receiving parameter set may include a first on-die termination (ODT) parameter and/or a first continuous time linear equalization (CTLE) parameter. The first parameter may be a first receiving parameter, and the first receiving parameter belongs to the first receiving parameter set. In other words, the first parameter may be the first ODT parameter or the first CTLE parameter. When receiving a signal sent by the storage apparatus, the first communications interface may receive the signal based on the first receiving parameter set.

The first transmitting parameter set may include one or more of a first driving capability parameter, a first output signal slope, or a first transmitter (Tx) equalization (EQ) parameter. When sending a signal to the storage apparatus, the first communications interface may send the signal by using the first transmitting parameter set. The first parameter may be a first transmitting parameter that belongs to the first receiving parameter set. In other words, the first parameter may be the first driving capability parameter, the first output signal slope, or the first Tx EQ parameter.

An ODT parameter is used to indicate a value of a resistor connected to a communications interface when the communications interface receives a signal. The first ODT parameter is used to indicate a value of a terminal resistor connected to the first communications interface when the first communications interface receives a signal sent by the storage apparatus.

When a digital signal is transmitted in a transmission line, the signal includes components of a plurality of frequencies, and a high-frequency component with a shorter wavelength relative to the transmission line forms a reflected wave at an end of the transmission line, which interferes with an original signal. In addition, a higher frequency indicates stronger formed reflection, which causes greater interference to a signal. A terminal resistor is added to the end of the transmission line, so that the reflection formed when a signal reaches the end of the transmission line can be reduced. However, a relatively large terminal resistor generates relatively large power consumption.

If a transmission channel is an ideal lossless transmission line, a signal sent by a transmitter occurs at a receiver without a loss. The receiver can naturally recover the signal very easily. However, because a skin effect and a dielectric loss exist on the transmission channel, the transmission channel usually shows a low-pass feature. A loss caused by the skin effect is directly proportional to a square root of a signal frequency, and the dielectric loss is directly proportional to the frequency. Therefore, when the frequency is relatively low, a channel loss is mainly determined by the skin effect. For a channel transmitting a high-frequency signal, the dielectric loss usually plays a leading role.

It is not attenuation that really affects reliable transmission of a signal, but a change of channel attenuation with a frequency. A signal attenuation difference eventually causes inter-symbol interference (ISI). Inter-symbol interference is mutual interference between different symbols. For example, a signal “1” transmitted at a moment A is superposed on a signal “0” transmitted at a moment B. A loss of a high-frequency component in a signal slows a signal edge, and the signal is broadened. A broadened signal may span a plurality of unit time intervals. Greater channel attenuation indicates more serious signal broadening and indicates that a greater proportion of the signal is superposed on a signal at another moment.

Equalization compensates for channel non-ideality at the transmitter or the receiver and eliminates inter-symbol interference, so that an eye diagram at the receiver is reopened. In the frequency domain, equalization is compensating for a low-pass feature of a channel by using a high-pass filter. In the time domain, equalization is reshaping a pulse response signal and limiting energy of the pulse response signal to one time interval to avoid inter-symbol interference.

In CTLE technology, a difference between high-frequency attenuation and low-frequency attenuation may be compensated for by amplifying a high-frequency signal at the receiver or by reducing a low-frequency signal. Generally, when a high-speed digital signal is transmitted through a lossy channel, a CTLE circuit at the receiver is configured to improve a high-frequency component of the signal to compensate for a high-frequency channel loss.

A frequency response of a channel may be considered as a low-pass filter. Therefore, a full-pass filter can be obtained by connecting a channel and a high-pass filter in series. The high-pass filter may not be an actual analog circuit. However, an equalization requirement can be met provided that a high-pass feature is present.

A CTLE parameter may include a frequency range and an amplification ratio that are provided for signal amplification. The first CTLE parameter is used to indicate a frequency range and an amplification ratio that are used by the first communications interface to amplify a received signal sent by the storage apparatus.

An eye diagram may represent the quality of a received signal. The eye diagram is a waveform diagram obtained by intercepting a waveform of a received signal based on a positive integer multiple of an inversion period of the received signal, and superimposing waveforms in inversion periods. A shape of the eye diagram is similar to an eye. The received signal can be correctly received only when the eye diagram of the received signal is opened. A random data signal is very rich in spectrum components. If a difference between attenuation of a high-frequency component and attenuation of a low-frequency component of the random data signal in a transmission line is relatively large, an eye diagram formed by the random data signal at the receiver may be closed, which causes a bit error at the receiver.

The first communications interface may separately use a plurality of receiving parameters with different values to receive a first test information sent by the storage apparatus.

The processor 110 may record signal quality information of the first test information received when the first communications interface uses the receiving parameter with each value.

In a plurality of pieces of recorded signal quality information, signal quality of the first test information received when the first communications interface uses the first receiving parameter is optimal. Therefore, the processor 110 may determine that a receiving parameter in the receiving parameters with a plurality of values that makes signal quality of the first test information received by the first communications interface optimal is the first receiving parameter. The first receiving parameter is the first parameter.

The signal quality information may be an eye diagram. An optimal eye diagram in a plurality of recorded eye diagrams indicates optimal signal quality data. The optimal eye diagram may be an eye diagram with a maximum eye width and a maximum eye height.

The receiving parameter may be a CTLE parameter or an ODT parameter. In other words, the first receiving parameter may be the first ODT parameter or the first CTLE parameter.

The CTLE parameter and the ODT parameter may be separately used as the receiving parameters, to determine the first CTLE parameter and the first ODT parameter.

Equalization can also be implemented by adjusting a signal at the transmitter.

In Tx EQ technology, a difference between high-frequency attenuation and low-frequency attenuation is compensated for through pre-emphasis or de-emphasis. Both de-emphasis and pre-emphasis are applied to a transmitter of a signal, and both are indented to balance a high-frequency component and a low-frequency component as far as possible, to reduce impact on a final result caused by the following: attenuation of a high-frequency component is greater than that of a low-frequency component on a transmission link.

A signal frequency is mainly determined by a change rate during signal level inversion, and a high-frequency component of a signal mainly occurs at signal inversion edges, such as a rising edge and a falling edge of the signal.

In the pre-emphasis technology, the high-frequency component of the signal is enhanced by increasing an amplitude at the rising edge and the falling edge of the signal at a transmitter to compensate for relatively large attenuation of the high-frequency component on the transmission link.

In the de-emphasis technology, the amplitude at the rising edge and the falling edge of the signal remains unchanged at the transmitter, and a signal in another place is weakened to weaken a low-frequency signal.

Compared with a signal obtained after compensation through pre-emphasis, a signal obtained after compensation through de-emphasis has a smaller swing, a lower eye diagram height, and smaller power consumption.

A Tx EQ parameter may be a pre-emphasis parameter or a de-emphasis parameter. The pre-emphasis parameter may include an enhanced amplitude and an enhanced time range that are at a signal inversion edge. The de-emphasis parameter may include a signal weakening amplitude and a time range of signal weakening.

A driving capability parameter may be used to indicate a current value of a sent signal. Due to a loss of a signal in transmission in a transmission line, if a driving capability is excessively small, the receiver cannot correctly receive a signal. Alternatively, if a driving capability is excessively large, in one aspect, the loss of the signal in the transmission line is relatively large, that is, relatively large power consumption is generated. In another aspect, enhancement of the driving capability causes relatively large signal strength at the receiver, and energy of a generated reflected signal is relatively large.

Therefore, determining a proper driving capability parameter can generate relatively small power consumption and interference while enabling a signal to be accurately transmitted.

A high-frequency component of a signal mainly occurs at an edge of signal inversion. An output signal slope may be a value obtained by dividing a changed voltage amount by time and is used to indicate a speed at which the voltage of the signal changes with time during signal inversion. If the output signal slope is higher, the speed at which the voltage of the signal changes with the time is larger, a maximum frequency of a high-frequency component in the signal is larger, and stronger reflection is formed at an end of a transmission line, which causes greater interference to the original signal.

The output signal slope restricts a signal inversion period, which consequently affects a signal transmission rate. A larger output signal slope indicates a larger minimum value of the signal inversion period, and a lower signal transmission rate.

Therefore, determining a proper output signal slope can reduce restriction on the signal transmission rate while producing relatively small interference.

The first communications interface may separately send second test information to the at least one storage apparatus by using a plurality of transmitting parameters with different values.

The first communications interface receives a plurality of pieces of third test information sent by the at least one storage apparatus. Each piece of third test information is the second test information received by the at least one storage apparatus; or each piece of third test information is the second test information that is received by the storage apparatus when the first communications interface sends the second test information by using a transmitting parameter with a specific value in the plurality of transmitting parameters with different values. The plurality of pieces of third test information are in a one-to-one correspondence with the plurality of transmitting parameters with different values.

The first communications interface sends the second test information to the storage apparatus. When the second test information is transmitted to the storage apparatus through a transmission line, the storage apparatus receives the third test information. If signal quality is relatively poor when the second test information is transmitted in the transmission line, the third test information received by the storage apparatus may be different from the second test information. The storage apparatus may send the third test information to the first communications interface, so that the processor 110 may determine whether the third test information matches the second test information, to determine signal quality of the second test information in transmission in the transmission line.

Sending and receiving of information by the first communications interface is controlled by the processor 110. When receiving different third test information, the first communications interface should use a same parameter.

The processor 110 may determine whether each piece of third test information matches the second test information. The processor 110 may determine that a transmitting parameter making the third test information match the second test information is the first transmitting parameter. A first parameter set includes the first transmitting parameter. In other words, in the plurality of transmitting parameters, the first transmitting parameter makes the third test information match the second test information. The first transmitting parameter is the first parameter.

In some embodiments, there are a plurality of transmitting parameters that make the third test information match the second test information. To determine the first transmitting parameter, a rated voltage of the second test information may be biased.

Generally, a communications interface sends information at a rated voltage. That the rated voltage of the second test information is biased means that a voltage at which the second test information is sent is obtained after the rated voltage is adjusted.

For each transmitting parameter, or for each transmitting parameter that makes the third test information match the second test information, the first communications interface separately sends the second test information to the storage apparatus based on the transmitting parameter at a plurality of different voltages obtained after the rated voltage is adjusted.

That information is sent at a voltage obtained after the rated voltage is adjusted may be adjusting, at the transmitter, an amplitude of a signal that carries the information.

When the second test information is transmitted to the storage apparatus through a transmission line, the storage apparatus receives the third test information. The storage apparatus may send the third test information to the first communications interface.

The first communications interface receives the plurality of pieces of third test information sent by the storage apparatus. The plurality of pieces of third test information are the second test information that is sent by the first communications interface at different voltages and that is received by the storage apparatus.

Therefore, a biased voltage range in which each transmitting parameter makes the third test information match the second test information can be determined. The biased voltage range is an adjustment range of the rated voltage.

A transmitting parameter that has a maximum biased voltage range and that makes the third test information match the second test information may be determined as the first transmitting parameter.

The transmitting parameter may be a driving capability parameter, an output signal slope, or a Tx EQ parameter. In other words, the first transmitting parameter may be the first driving capability parameter, the first output signal slope, or the first Tx EQ parameter.

One or more of the driving capability parameter, the output signal slope, or the Tx EQ parameter may be separately used as the transmitting parameters, to determine the first transmitting parameter set.

A second parameter corresponding to each storage apparatus may be further determined.

The first communications interface may send parameter indication information to each storage apparatus. The parameter indication information includes the second parameter corresponding to the storage apparatus, and the parameter indication information is used to indicate the storage apparatus to communicate with the first communications interface by using the received second parameter.

The second parameter corresponding to each storage apparatus is determined, and each storage apparatus is indicated to communicate with the first communications interface based on the second parameter corresponding to the storage apparatus, so that SI performance in communication between the processing apparatus and the storage apparatus can be improved.

A second parameter set may include a parameter in a second receiving parameter set or a second transmitting parameter set.

The second receiving parameter set may include a second ODT parameter and/or a second CTLE parameter. When the storage apparatus receives a signal sent by the first communications interface, a second communications interface that is of the storage apparatus and that is connected to the first communications interface may receive the signal based on the second receiving parameter set.

The second transmitting parameter set may include one or more of a second driving capability parameter, a second output signal slope, or a second transmitter Tx EQ parameter. When the storage apparatus sends a signal to the first communications interface, the second communications interface of the storage apparatus may send the signal by using the second transmitting parameter set.

In other words, the second parameter may be a second terminal-matched resistor ODT parameter, the second driving capability parameter, the second output signal slope, the second Tx EQ parameter, a second CTLE parameter, or the like.

The first communications interface may receive a fourth test information sent by the second communications interface of the storage apparatus by using a plurality of transmitting parameters of the storage apparatus that are with different values.

For example, a processing apparatus may send indication information to the storage apparatus, where the indication information is used to indicate the second communications interface of the storage apparatus to send the fourth test information by using a plurality of transmitting parameters of the storage apparatus that are with different values.

Signal quality information of the fourth test information received by the first communications interface when the second communications interface of the storage apparatus uses the transmitting parameter that is of the storage apparatus and that is with each value may be recorded.

The processor 110 may determine, in a plurality of pieces of recorded signal quality information, that a transmitting parameter that is of the storage apparatus and that is used by the second communications interface when signal quality of the fourth test information received by the first communications interface is optimal is a second transmitting parameter. The second parameter set includes the second transmitting parameter.

The plurality of transmitting parameters of the storage apparatus that are with different values may be driving capability parameters with different values, output signal slopes with different values, or transmitter Tx EQ parameters with different values. In other words, the second transmitting parameter may be the second driving capability parameter, the second output signal slope, or the second transmitter Tx EQ parameter.

One or more of the driving capability parameter, the output signal slope, or the transmitter Tx EQ parameter may be separately used as the transmitting parameters of the storage apparatus, to determine each parameter in the second transmitting parameter set.

The first communications interface may send a plurality of pieces of fifth test information to the storage apparatus, and the storage apparatus separately receives the plurality of pieces of fifth test information by using a plurality of receiving parameters of the storage apparatus that are with different values.

The first communications interface receives a plurality of pieces of sixth test information sent by the storage apparatus. All the sixth test information is the fifth test information received by the storage apparatus by using receiving parameters of the storage apparatus that are with different values.

A receiving parameter of the storage apparatus that makes the sixth test information match the fifth test information may be determined as a second receiving parameter.

When there are a plurality of receiving parameters of the storage apparatus that make the sixth test information match the fifth test information, biased voltage ranges that correspond to different receiving parameters of the storage apparatus and in which the sixth test information matches the fifth test information in may be determined. A receiving parameter that is of the storage apparatus and that has a maximum biased voltage range and makes the sixth test information match the fifth test information may be determined as the second receiving parameter.

When the first communications interface of the processor 110 is connected to a plurality of storage apparatuses, a second parameter set corresponding to each storage apparatus may be determined. In other words, when the first communications interface of the processor 110 is connected to a plurality of storage apparatuses, for each storage apparatus, a second receiving parameter and/or a second transmitting parameter of the storage apparatus are/is determined.

A first parameter set may include each parameter in a first receiving parameter set and/or a first transmitting parameter set.

If the first parameter set includes a plurality of parameters, when one parameter in the first parameter set is determined, the first communications interface may communicate with the at least one storage apparatus by using the parameter. If the second parameter set includes a plurality of parameters, when one parameter in the second parameter set is determined, the first communications interface may send the parameter to the storage apparatus, so that the storage apparatus communicates with the first communications interface by using the parameter.

Through S210 to S220, the first communications interface no longer communicates with the storage apparatus based on a configured parameter. Instead, a parameter is determined, and the first communications interface communicates with the storage apparatus based on the determined parameter, to improve signal quality in communication with the storage apparatus and improve signal integrity.

As SI performance in communication between the first communications interface and the storage apparatus improves, a rate of communication between the first communications interface and the storage apparatus may be improved.

An increase in a quantity of storage apparatuses connected to the first communications interface leads to signal reflection enhancement and SI performance degradation. A parameter used for communication between the first communications interface and a communications interface of the storage apparatus is determined to improve SI performance in communication between the first communications interface and the storage apparatus, so that a quantity of storage apparatuses connected to the first communications interface can be increased, and a load capability can be improved.

When the first communications interface is connected to a plurality of storage apparatuses, when a specific storage apparatus sends data to the first communications interface, another storage apparatus may use a relatively large ODT resistor to reduce reflection caused to a signal.

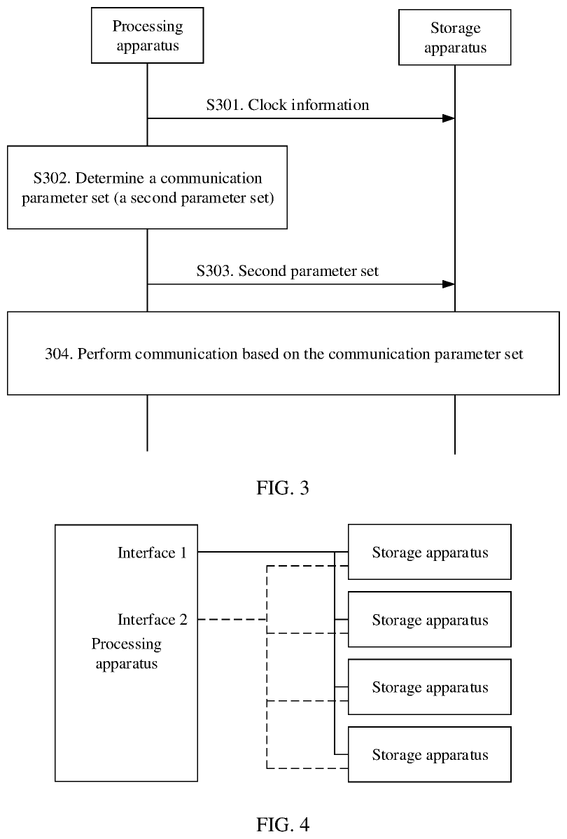

FIG. 3 is a schematic flowchart of a communication method according to an embodiment.

A storage apparatus includes a storage apparatus and at least one second communications interface. A memory may be a synchronous memory or an asynchronous memory. A synchronization memory is used as an example for description in FIG. 3.

Data exchange between the storage apparatus and a processing apparatus is based on a clock signal. For example, the second communications interface of the storage apparatus receives a signal at a rising edge of the clock signal.

A processing apparatus includes a processor 110 and at least one first communications interface. When the processor 110 is initialized, S301 to S304 may be performed for each first communications interface connected to the processor 110.

The first communications interface is connected to at least one storage apparatus.

S301: The processing apparatus provides a clock signal to the storage apparatus.

The processor 110 adjusts a cycle start time point based on a preset clock cycle, to provide the storage apparatus with a plurality of test clock signals with different cycle start time points, and when providing each test clock signal, controls the first communications interface to send test information to the storage apparatus. The storage apparatus sends the received test information. The processor 110 records a received clock signal sent by the storage apparatus as a receiving signal, and provides, as a clock signal, a test clock signal that makes the receiving signal match the test information to the storage apparatus.

The cycle start time point is adjusted, so that the storage apparatus can accurately receive information sent by the processor 110.

For example, the processing apparatus may send information with a relatively low inversion frequency to the storage apparatus by using the first communications interface. The information with a relatively low inversion frequency has a relatively low requirement for signal quality.

S302: The processing apparatus determines a communication parameter set.

The communication parameter set may include a first parameter set and/or a second parameter set.

The first parameter set may include, for example, one or more of a first ODT parameter, a first driving capability parameter, a first output signal slope, a first Tx EQ parameter, a first CTLE parameter, or another parameter.

The first ODT parameter and the first CTLE parameter in the first parameter set may be applied to a stage in which the processing apparatus receives a signal sent by the storage apparatus. The first driving capability parameter, the first output signal slope, and the first Tx EQ parameter are applied to a stage in which the processing apparatus sends a signal to the storage apparatus.

The second parameter set may include, for example, one or more of a second ODT parameter, a second driving capability parameter, a second output signal slope, a second Tx EQ parameter, a second CTLE parameter, or another parameter.

The second ODT parameter and the second CTLE parameter in the second parameter set may be applied to a stage in which the storage apparatus receives a signal sent by the processing apparatus. The second driving capability parameter, the second output signal slope, and the second Tx EQ parameter are applied to a stage in which the storage apparatus sends a signal to the processing apparatus.

In a process of communication between the processing apparatus and the storage apparatus, only one equalization manner may be used. To be specific, when the first parameter set includes the first CTLE parameter, the second parameter set may not include the second Tx EQ parameter. When the first parameter set includes the first Tx EQ parameter, the second parameter set may not include the second CTLE parameter.

A sequence in which the processor 110 determines the parameters in the communication parameter set is not limited in this embodiment. For example, the processor 110 may determine parameters in the first parameter set in a sequence of sequentially determining a driving capability parameter, an ODT parameter, a Tx EQ parameter, a CTLE parameter, and an output signal slope of a communications interface of the processing apparatus, and then determine parameters in the second parameter set.

In some embodiments, when determining a parameter in the communications parameter set, the processing apparatus may send test information with a relatively high inversion frequency to the storage apparatus by using the first communications interface.

When the communication parameter set includes a parameter in the second parameter set, S303 is performed.

S303: The processing apparatus sends the second parameter set to the storage apparatus to indicate the storage apparatus to communicate with the processing apparatus based on the second parameter set.

S304: The first communications interface of the processing apparatus uses the first parameter set to perform communication, and the storage apparatus uses the second parameter set to perform communication.

As shown in FIG. 4, the first communications interface of the processing apparatus is connected to a plurality of storage apparatuses. The processing apparatus and the plurality of storage apparatuses may be located on a same printed circuit board (PCB); or the processing apparatus and the plurality of storage apparatuses may be separately located on different PCBs. For example, each storage apparatus may be a memory board or the like.

The storage apparatus may be a dual in-line memory module (DIMM), such as an unbuffered dual in-line memory module (UDIMM), a registered dual in-line memory module (RDIMM), a load-reduced dual in-line memory module (LRDIMM), or a small outline dual in-line memory module (SODIMM). A memory specification of the storage apparatus may be a double data rate (DDR) 4, a DDR 5, or the like.

The first communications interface may be connected to a plurality of storage apparatuses. S301 to S304 may be performed for each storage apparatus. To be specific, a clock signal may be provided to each storage apparatus, and a second parameter set of each storage apparatus may be determined.

A first receiving parameter set may be further determined for each storage apparatus. When receiving information sent by a specific storage apparatus, the processing apparatus may receive the information by using the first receiving parameter set corresponding to the storage apparatus to further improve communication quality.

When sending information, the processor 110 usually sends the information to the plurality of storage apparatuses. Therefore, a first transmitting parameter set may be applied to a case in which the information is sent to all the storage apparatuses.

The processing apparatus may include a plurality of first communications interfaces, such as an interface 1 and an interface 2 shown in FIG. 4. The interface 1 may be a data signal interface, and the interface 2 may be an address command signal interface. The data signal interface 1 of the processing apparatus is connected to a data signal interface of each storage apparatus, and the address command signal interface 2 of the processing apparatus is connected to an address command signal interface of each storage apparatus.

The data signal interface 1 of the processing apparatus is configured to send data to the data signal interface of the storage apparatus and is further configured to receive data sent by the data signal interface of the storage apparatus. In other words, the data signal interface is used for data transmission.

The address command signal interface 2 of the processing apparatus is configured to send data sending address information and a read request or a write request to the address command signal interface of the storage apparatus.

During a write operation, the processing apparatus sends a write request and address information to the plurality of storage apparatuses by using the address command signal interface 2. Each storage apparatus determines whether the address information indicates an address in the storage apparatus. For example, a storage apparatus in the plurality of storage apparatuses determines that the address information indicates an address in the storage apparatus. The processing apparatus sends data to the storage apparatus by using the data signal interface 1. The storage apparatus writes the data into the address indicated by the address information.

During a read operation, the processing apparatus sends a read request and address information to the plurality of storage apparatuses by using the address command signal interface 2. Each storage apparatus determines whether the address information indicates an address in the storage apparatus. For example, a storage apparatus in the plurality of storage apparatuses determines that the address information indicates an address in the storage apparatus. The storage apparatus 1 sends, to the processing apparatus by using the data signal interface 1, data in the address indicated by the address information.

The independent data signal interface 1 and address command signal interface 2 in the processing apparatus each may be a memory channel. S301 to S304 may be separately performed for the data signal interface 1 and the address command signal interface 2.

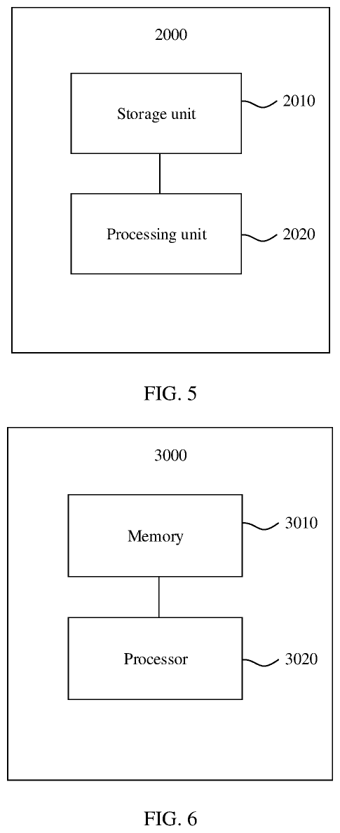

FIG. 5 is a schematic diagram of a structure of an electronic apparatus according to an embodiment.

An electronic apparatus 2000 includes a storage unit 2010 and a processing unit 2020. The storage unit 2010 is configured to store a program, and when the program is executed in the processing unit 2020, the processing unit 2020 is configured to:

determine a first parameter corresponding to a communications interface, where the communications interface is connected to at least one storage apparatus; and

control the communications interface to communicate with the at least one storage apparatus based on the first parameter.

The storage unit 2010 may be one of the at least one storage apparatus or may be another storage apparatus.

Optionally, the processing unit 2020 is further configured to control the communications interface to separately receive, by using a plurality of receiving parameters with different values, first test information sent by the at least one storage apparatus.

The processing unit 2020 is further configured to record signal quality information of the first test information received when the communications interface uses the receiving parameter with each value, where the first test information that is received when the communications interface uses the first parameter has optimal signal quality data in a plurality of pieces of recorded signal quality information.

Optionally, the first parameter is an ODT parameter or a continuous time linear equalization (CTLE) parameter.

Optionally, the processing unit 2020 is further configured to control the communications interface to separately send second test information to the at least one storage apparatus by using a plurality of transmitting parameters with different values.

The processing unit 2020 is further configured to control the communications interface to receive a plurality of pieces of third test information sent by the at least one storage apparatus, where each piece of third test information is the second test information received by the at least one storage apparatus, the plurality of pieces of third test information are in a one-to-one correspondence with the plurality of transmitting parameters, and the first parameter in the plurality of transmitting parameters makes the third test information corresponding to the first receiving parameter match the second test information.

Optionally, in the plurality of transmitting parameters, there are a plurality of first transmitting parameters that make the third test information match the second test information, and the first parameter in the plurality of first transmitting parameters has a largest biased voltage range.

Optionally, the first parameter is a driving capability parameter, an output signal slope, or a transmitter equalization (EQ) parameter.

Optionally, the processing unit 2020 is further configured to determine a second parameter corresponding to each storage apparatus.

The processing unit 2020 is further configured to control the communications interface to send parameter indication information to each storage apparatus, where the parameter indication information includes the second parameter corresponding to the storage apparatus, and the parameter indication information is used to indicate the storage apparatus to communicate with a processing apparatus by using the received second parameter.

FIG. 6 is a schematic diagram of a structure of an electronic apparatus according to an embodiment.

An electronic apparatus 3000 includes a memory 3010 and a processor 3020. The memory 3010 is configured to store a program, and when the program is executed in the processor 3020, the processor 3020 is configured to:

determine a first parameter corresponding to a communications interface, where the communications interface is connected to at least one storage apparatus; and

control the communications interface to communicate with the at least one storage apparatus based on the first parameter.

The memory 3010 may be one of the at least one storage apparatus, or may be another storage apparatus.

Optionally, the processor 3020 is further configured to control the communications interface to separately receive, by using a plurality of receiving parameters with different values, first test information sent by the at least one storage apparatus.

The processor 3020 is further configured to record signal quality information of the first test information received when the communications interface uses the receiving parameter with each value, where the first test information that is received when the communications interface uses the first parameter in the plurality of receiving parameters has optimal signal quality data in a plurality of pieces of recorded signal quality information.

Optionally, the first parameter is an ODT parameter or a continuous time linear equalization (CTLE) parameter.

Optionally, the processor 3020 is further configured to control the communications interface to separately send second test information to the at least one storage apparatus by using a plurality of transmitting parameters with different values.

The processor 3020 is further configured to control the communications interface to receive a plurality of pieces of third test information sent by the at least one storage apparatus, where each piece of third test information is the second test information received by the at least one storage apparatus, the plurality of pieces of third test information are in a one-to-one correspondence with the plurality of transmitting parameters, and the first parameter in the plurality of transmitting parameters makes the third test information corresponding to the first parameter match the second test information.

Optionally, in the plurality of transmitting parameters, there are a plurality of first transmitting parameters that make the third test information match the second test information, and the first parameter in the plurality of first transmitting parameters has a largest biased voltage range.

Optionally, the first parameter is a driving capability parameter, an output signal slope, or a transmitter equalization (EQ) parameter.

Optionally, the processor 3020 is further configured to determine a second parameter corresponding to each storage apparatus.

The processor 3020 is further configured to control the communications interface to send parameter indication information to each storage apparatus, where the parameter indication information includes the second parameter corresponding to the storage apparatus, and the parameter indication information is used to indicate the storage apparatus to communicate with a processing apparatus by using the received second parameter.

An embodiment further provides a processing apparatus, including a communications interface and the electronic apparatus described above. An embodiment of this application further provides a non-transitory computer-readable medium. The non-transitory computer-readable medium stores program code to be executed by a device, and when the program code is executed by the device, the device performs the method described above.

An embodiment further provides a chip, and the chip includes a processor and a data interface. The processor reads, through the data interface, instructions stored in a memory to perform the method described above.

An embodiment further provides an electronic system, including at least one storage apparatus and the electronic device described above.

The processor in the embodiments may be a central processing unit (CPU). The processor may further be another general-purpose processor, a digital signal processor (DSP), an application-specific integrated circuit (ASIC), a field programmable gate array (FPGA), or another programmable logic device, discrete gate or transistor logic device, discrete hardware component, or the like. The general-purpose processor may be a microprocessor, or the processor may be any conventional processor or the like.

The memory in the embodiments may be a volatile memory or a nonvolatile memory, or may include a volatile memory and a nonvolatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM) that is used as an external buffer. Through an example rather than a limitative description, random access memories (random access memory, RAM) in many forms may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM).

All or some of the foregoing embodiments may be implemented by software, hardware, firmware, or any combination thereof. When software is used to implement the embodiments, all or some of the foregoing embodiments may be implemented in a form of a computer programthat includes one or more computer instructions or computer programs. When the program instructions or the computer programs are loaded and executed on a computer, the procedure or functions according to the embodiments are all or partially generated. The computer may be a general-purpose computer, a dedicated computer, a computer network, or another programmable apparatus. The computer instructions may be stored in a non-transitory computer-readable storage medium or may be transmitted from a non-transitory computer-readable storage medium to another non-transitory computer-readable storage medium. For example, the computer instructions may be transmitted from a website, computer, server, or data center to another website, computer, server, or data center in a wired (for example, infrared, radio, or microwave) manner. The non-transitory computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), or a semiconductor medium. The semiconductor medium may be a solid-state drive.

The term “and/or” in this specification describes only an association relationship between associated objects and represents that three relationships may exist. For example, A and/or B may represent the following three cases: only A exists, both A and B exist, and only B exists. A and B may be singular or plural. In addition, the character “/” in this specification usually represents an “or” relationship between the associated objects, or may represent an “and/or” relationship. A specific meaning depends on a context.

“At least one” means one or more, and “a plurality of” means two or more. “At least one of the following items (pieces)” or a similar expression thereof indicates any combination of these items, including a single item (piece) or any combination of a plurality of items (pieces). For example, at least one item (piece) of a, b, or c may represent: a, b, c, a and b, a and c, b and c, or a, b, and c, where a, b, and c may be singular or plural.

In the embodiments, sequence numbers of the foregoing processes may not mean execution sequences. The execution sequences of the processes should be determined based on functions and internal logic of the processes and should not constitute any limitation to implementation processes of the embodiments.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on design constraints of the solutions. A person skilled in the art may use different methods to implement the described functions, but it should not be considered that the implementation goes beyond the scope.

For the purpose of convenient and brief description, a detailed working process of the foregoing system, an apparatus, and a unit, refer to a corresponding process in the foregoing method embodiments. Details are not described herein again.

In the several embodiments, the disclosed system, apparatus, and method may be implemented in other manners. For example, the described apparatus embodiments are merely examples. For example, division into units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or another form.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, function units in the embodiments may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the solutions essentially, or the part contributing to the conventional technology, or some of the solutions may be implemented in a form of a software product. The computer software product is stored in a storage medium, and includes several instructions for instructing a computer device (which may be a personal computer, a server, a network device, or the like) to perform all or some of the steps of the methods described in the embodiments. The foregoing storage medium includes various media that can store program code, such as a USB flash drive, a removable hard disk, a read-only memory (ROM), a random access memory (RAM), a magnetic disk, and an optical disc.

The foregoing descriptions are merely implementations, but are not intended to limit the protection scope. Any variation or replacement readily figured out by a person skilled in the art within the scope shall fall within the protection scope. Therefore, the protection scope shall be subject to the protection scope of the claims.

1. A method comprising:
determining a first parameter corresponding to a communications interface, wherein the communications interface is connected to at least one storage apparatus; and
controlling the communications interface to communicate with the at least one storage apparatus based on the first parameter.

2. The method according to claim 1, further comprising:
controlling the communications interface to separately receive, by using a plurality of receiving parameters with different values, first test information sent by the at least one storage apparatus; and
recording signal quality information of the first test information received when the communications interface uses the receiving parameter with each value, wherein the first test information that is received when the communications interface uses the first parameter in the plurality of receiving parameters has optimal signal quality data in a plurality of pieces of recorded signal quality information.

3. The method according to claim 2, wherein the first parameter is an on-die termination (ODT) parameter or a continuous time linear equalization (CTLE) parameter.

4. The method according to claim 3, further comprising:
controlling the communications interface to separately send second test information to the at least one storage apparatus by using a plurality of transmitting parameters with different values; and
controlling the communications interface to receive a plurality of pieces of third test information sent by the at least one storage apparatus, wherein each piece of third test information is the second test information received by the at least one storage apparatus, the plurality of pieces of third test information are in a one-to-one correspondence with the plurality of transmitting parameters, and the first parameter in the plurality of transmitting parameters makes the third test information match the second test information.

5. The method according to claim 4, wherein in the plurality of transmitting parameters, there are a plurality of transmitting parameters that make the third test information match the second test information, and the first parameter in the plurality of transmitting parameters has a largest biased voltage range.

6. The method according to claim 5, wherein the first parameter is a driving capability parameter, an output signal slope, or a transmitter equalization (EQ) parameter.

7. The method according to claim 6, further comprising:
determining a second parameter corresponding to each storage apparatus; and
controlling the communications interface to send parameter indication information to each storage apparatus, wherein the parameter indication information comprises the second parameter corresponding to the storage apparatus, and the parameter indication information is used to indicate the storage apparatus to communicate with a processing apparatus by using the received second parameter.

8. A processing apparatus, comprising a processor and a memory, wherein the memory is configured to store a program, and when the program is executed in the processor, the processor is configured to:
determine a first parameter corresponding to a communications interface, wherein the communications interface is connected to at least one storage apparatus; and
control the communications interface to communicate with the at least one storage apparatus based on the first parameter.

9. The processing apparatus according to claim 8, wherein the processor is further configured to:
control the communications interface to separately receive, by using a plurality of receiving parameters with different values, first test information sent by the at least one storage apparatus; and
record signal quality information of the first test information received when the communications interface uses the receiving parameter with each value, wherein the first test information that is received when the communications interface uses the first parameter has optimal signal quality data in a plurality of pieces of recorded signal quality information.

10. The processing apparatus according to claim 9, wherein the first parameter is an on-die termination (ODT) parameter or a continuous time linear equalization (CTLE) parameter.

11. The processing apparatus according to claim 10, wherein the processor is further configured to:
control the communications interface to separately send second test information to the at least one storage apparatus by using a plurality of transmitting parameters with different values; and
control the communications interface to receive a plurality of pieces of third test information sent by the at least one storage apparatus, wherein each piece of third test information is the second test information received by the at least one storage apparatus, the plurality of pieces of third test information are in a one-to-one correspondence with the plurality of transmitting parameters, and the first parameter in the plurality of transmitting parameters makes the third test information corresponding to the first receiving parameter match the second test information.

12. The processing apparatus according to claim 11, wherein in the plurality of transmitting parameters, there are a plurality of transmitting parameters that make the third test information match the second test information, and the first parameter in the plurality of transmitting parameters has a largest biased voltage range.

13. The processing apparatus according to claim 12, wherein the first parameter is a driving capability parameter, an output signal slope, or a transmitter equalization (EQ) parameter.

14. The processing apparatus according to claim 13, wherein the processor is further configured to:
determine a second parameter corresponding to each storage apparatus; and
control the communications interface to send parameter indication information to each storage apparatus, wherein the parameter indication information comprises the second parameter corresponding to the storage apparatus, and is used to indicate the storage apparatus to communicate with the processing apparatus by using the received second parameter.

15. An electronic device, comprising a communications interface and the processing apparatus according to claim 8.

16. A non-transitory computer-readable storage medium, wherein the non-transitory computer-readable medium stores program code to be executed by a device, and when the program code is executed by the device, the device performs the method according to claim 1.

17. An electronic system, comprising at least one storage apparatus and the electronic device according to claim 15.
